(19) United States
(12) Patent Application Publication
(10) Pub. No.: US 2008/0240379 A1
(43) Pub. Date: Oct. 2, 2008

(54) Automatic retrieval and presentation of information relevant to the context of a user's conversation

(75) Inventors: Ariel Maislos, Sunnyvale, CA (US); Ruben Maislos, Or-Yehuda (IL); Eran Arbel, Cupertino, CA (US)

Correspondence Address: DR. MARK FRIEDMAN LTD.;C/o Bill Polkinghorn, 9003 Florin Way, Upper Marlboro, MD, 20772, US

(73) Assignee: Pudding Ltd.

(21) Appl. No.: 11/882,479

(22) Filed: Aug. 2, 2007

Related U.S. Application Data
(60) Provisional application No. 60/821,272, filed on Aug. 3, 2006.
(60) Provisional application No. 60/824,323, filed on Sep. 1, 2006.
(60) Provisional application No. 60/862,771, filed on Oct. 25, 2006.

(51) Int. Cl. H04M 11/00

(52) U.S. Cl. 379/88.13

(57) ABSTRACT

Methods, apparatus and computer-code for electronically retrieving and presenting information are disclosed herein. In some embodiments, information is retrieved and presented in accordance with at least one feature of electronic media content of a multi-party conversation. Optionally, the multi-party conversation is a video conversation and at least one feature is a video content feature. Exemplary features include but are not limited to speech delivery features, key word features, topic features, background sound or image features, deviation features and biometric features.

### CROSS-REFERENCE TO RELATED APPLICATIONS

This patent application claims the benefit of U.S. Provisional Patent Application No. 60/821,272 filed Aug. 2, 2006 by the present inventors, and U.S. Provisional Patent Application No. 60/824,323 filed Sep. 1, 2006 by the present inventors

### FIELD OF THE INVENTION

The present invention relates to techniques for information retrieval and presentation.

### BACKGROUND AND RELATED ART

Knowledge bases contain enormous amounts of information on any topic imaginable. To tap this information, however, users need to explicitly issue a search request. The explicit search process requires the user to:

(i) realize that he needs a specific piece of information;

(ii) select the information source(s)

(iii) formulate a query expression and execute it against the information.

The following published patent applications provide potentially relevant background material: US 2006/0167747; US 2003/0195801; US 2006/0188855; US 2002/0062481; and US 2005/0234779. All references cited herein are incorporated by reference in their entirety. Citation of a reference does not constitute an admission that the reference is prior art.

### SUMMARY

The present inventors are now disclosing a technique wherein a multi-party voice conversation is monitored (i.e. by monitoring electronic media content of the multi-party voice conversation), and in accordance with at least one feature of the electronic media content, information is retrieved and presented to at least one conversation party of the multi-party voice conversation.

Exemplary information sources from which information is retrieved include but are not limited to search engines, news services, images or video banks, RSS feeds, and blogs. The information source may be local (for example, the local file system of a desktop computer or PDA) and/or may be remote (for example, a remote “Internet” search engine accessible via the Internet).

Not wishing to be bound by any theory, it is noted that by monitoring the multi-party voice conversation that is not directed to an entity doing the monitoring, an “implicit information retrieval request” may be formulated, thereby relieving the user of any requirement to explicitly formulate an information retrieval request and direct that information retrieval request to an information retrieval service.

Furthermore, the present inventors are now disclosing that the nature of the information retrieval and/or presentation of the retrieved information may be adapted to certain detectable features of the conversation and/or features of the conversation participants.

In one example, a demographic profile of a given user may be generated (i.e. either from detectable features of the conversation and/or other information sources). Thus, in one particular example, two individuals are speaking to each other in English (for example, using a “Skype” connection, or on cell phones), but one of the individuals has a Spanish accent. According to this example, the individual with the Spanish accent may be presented with retrieved Spanish-language information (for example, from a Spanish-language newswire retrieved using “keywords” translated from the English language conversation).

In another example related to retrieval and/or presentation of information in accordance with a demographic profile, two users are speaking about applying to law-school. One speaker is younger (say less than 25 years old) and another speaker is over 40. The “age demographic” of the speakers is detected from electronic media content of the multi-party conversation, and the older user may be served an article about law-school essay strategies for older law-school applicants, while the younger user may be served a profile from a dating website for college-aged students interested in dating a pre-law major.

If, for example, one user is speaking on a cell phone in Boston and the user is speaking on a cell phone in Florida, the Boston-based user may be provided information about New England law schools while the Florida-based user may be provided information about Florida law schools. This is an example of retrieving information according to a location of a participant in a multi-party conversation.

In another example related to retrieval and/or presentation of information in accordance with a demographic profile, a man and woman may be speaking about movies, and the “gender demographic” is detected. The man may be served information (for example, movie starting times) about movies popular with men (for example, horror movies, action movies, etc) while the woman may be served information about movies popular with women (for example, romance women). If the man is located on the “north side of town” and the woman on the “south side of town,” the man may be provided information about movie start times on the “north side” while the woman is provide information about movie start times on the “south side.”

In another example, information may be retrieved and/or presented in accordance with an emotion of one or more conversation-participants. For example, if it is detected that a person is angry, a link to anger-management material may be presented. In a similar example, if it is detected that a person is angry, a link to a clip of relaxing music may be presented.

In another example related to emotion-based information retrieval, if two people are speaking about a given rock-and-roll band, links to clips of the band's music may be presented. In one variation, certain songs of the rock-and-roll band may be pre-categorized as “happy songs” or “sad songs.” If one or both of the conversation-participants are detected as “happy” (for example, according to key words, body language, and/or voice tones), then links to clips of “happy songs” are presented.

In another example, information may be retrieved and/or presented in accordance with a “conversation participants relation.” Thus, if it is determined or assessed that two conversation participants are spouses or lovers, when they speak about the particular rock-and-roll band, links to clips to “love songs” from this band are presented to the users. Alternatively, if it is determined that two conversation participants are not friends or lovers but only business acquaintances, the “most popular” songs from the band may be presented to the users instead, and the “romantic” songs may be filtered out.

In another example, information may be retrieved and/or presented in accordance with a physiological status feature of the user. In this example, if a user coughs often during the conversation, a link to a Wikipedia article or a Medscape article about the flu may be presented to the user.

In another example, information may be retrieved and/or presented in accordance with one or more personality traits personality-profile feature of the user. According to one particular example, if an “extroverted” or “people-oriented” person would, when discussing a certain city with a friend, receive information about “people-oriented” activities that are done in groups. Conversely, an “introverted” person may receive information about activities done in solitude.

It is now disclosed for the first time a method of providing information-retrieval services. The method includes the steps of: a) monitoring a multi-party voice conversation not directed at the entity doing the monitoring; and b) in accordance with content of the monitored voice conversation, retrieving and presenting information to at least one party of the multi-party voice conversation.

Non-limiting examples of information items that may be retrieved include but are not limited to i) a social-network profile; ii) a weather forecast; iii) a traffic forecast; iv) a Wikipedia entry; v) a news article; vi) an online forum entry; vii) a blog entry; viii) a social bookmarking web service entry; ix) a music clip; and x) a film clip.

According to some embodiments, the retrieving includes assigning a keyword weight in accordance with an demographic parameter of a given party of the multi-party voice conversation estimated from electronic media of the multi-party conversation, the estimated demographic parameter being selected from the group consisting of: i) an age parameter; ii) a gender parameter; and iii) an ethnicity parameter.

According to some embodiments, the retrieving includes selecting or emphasizing an information-source from a plurality of candidate information-sources in accordance with an demographic parameter of a given party of the multi-party voice conversation estimated from electronic media of the multi-party conversation, the estimated demographic parameter being selected from the group consisting of: i) an age parameter; ii) a gender parameter; and iii) an ethnicity parameter.

According to some embodiments, the retrieving includes effecting a disambiguation in accordance with an demographic parameter of a given party of the multi-party voice conversation estimated from electronic media of the multi-party conversation, the estimated demographic parameter being selected from the group consisting of: i) an age parameter; ii) a gender parameter; and iii) an ethnicity parameter.

According to some embodiments, the assigning includes assigning a keyword weight in accordance with a speech delivery feature of a given party of the multi-party voice conversation estimated from electronic media of the multi-party conversation the speech delivery feature being selected from the group consisting of: i) a loudness parameter; ii) a speech tempo parameter; and iii) an emotional outburst parameter.

According to some embodiments, the retrieving includes selecting or emphasizing an information-source from a plurality of candidate information-sources in accordance with a geographic location of a given party of the multi-party voice conversation estimated from electronic media of the multi-party conversation.

According to some embodiments, the retrieving includes selecting or emphasizing an information-source from a plurality of candidate information-sources in accordance with an accent feature of at least one given party of the multi-party voice conversation.

According to some embodiments, the retrieving includes assigning a keyword weight in accordance with an demographic parameter of a given party of the multi-party voice conversation estimated from electronic media of the multi-party conversation, the estimated demographic parameter being selected from the group consisting of: i) an age parameter; ii) a gender parameter; and iii) an ethnicity parameter.

According to some embodiments, the information-presenting for a first set of words extracted from the multi-party conversation includes displacing earlier-presented retrieved information associated with a second earlier set of words extracted from the multi-party conversation in accordance with relative speech delivery parameters of the first and second set extracted words in accordance with a speech delivery feature being selected from the group consisting of: i) a loudness parameter; ii) a speech tempo parameter; and iii) an emotional outburst parameter.

According to some embodiments, the multi-party voice conversation is carried out between a plurality of client terminal devices communicating via a wide-area network, and for a given client device of the client device plurality: i) the information retrieval is carried out for incoming content relative to the given client device; and ii) the information presenting is on a display screen of the given client device.

It is now disclosed for the first time a method of providing information-retrieval services, the method comprising: a) monitoring a terminal device for incoming media content and outgoing media content of a multi-party conversation; and b) in accordance with the incoming media content, retrieving information over a remote network and presenting the retrieved information on the monitored-terminal device.

According to some embodiments, the retrieving includes sending content of the multi-party conversation to an Internet search engine, and the presenting includes presenting search results from the Internet search engine.

According to some embodiments, the retrieving includes retrieving at least one of: i) a social-network profile; ii) a weather forecast; iii) a traffic forecast; iv) a Wikipedia entry; v) a news article; vi) an online forum entry; vii) a blog entry; viii) a social bookmarking web service entry; ix) a music clip; and x) a film clip.

It is now disclosed for the first time a method of providing information-retrieval services, the method comprising: a) monitoring a given terminal client device for an incoming or outgoing remote call; and b) upon detecting a the incoming or outgoing remote call, sending content of the detected incoming call or outgoing call over a wide-area network to a search engine; and c) presenting search results from the search engine on the monitored terminal device.

A Discussion of Various Features of Electronic Media Content

According to some embodiments, the at least one feature of the electronic media content includes at least one speech delivery feature i.e. describing how a given set of words is delivered by a given speaker. Exemplary speech delivery features include but are not limited to: accent features (i.e. which may be indicative, for example, of whether or not a person is a native speaker and/or an ethnic origin), speech tempo features (i.e. which may be indicative of a mood or emotional state), voice pitch features (i.e. which may be indicative, for example, of an age of a speaker), voice loudness features, voice inflection features (i.e. which may indicative of a mood including but not limited to angry, confused, excited, joking, sad, sarcastic, serious, etc) and an emotional outburst feature (defined here as a presence of laughing and/or crying).

In another example, a speaker speaks some sentences or words loudly, or in an excited state, while other sentences or words are spoken more quietly. According to this example, when retrieving and/or presenting information, different words are given a different “weight” accordance to an assigned importance, and words or phrases spoken “loudly” or in an “excited stated” are given a higher weight than words or phrases spoken quietly.

In some embodiments, the multi-party conversation is a video conversation, and the at least one feature of the electronic media content includes a video content feature.

Exemplary video content features include but are not limited to:

i) visible physical characteristic of a person in an image—including but not limited to indications of a size of a person and/or a person's weight and/or a person's height and/or eye color and/or hair color and/or complexion;

ii) feature of objects or person's in the ‘background’—i.e. background object other than a given speaker—for example, including but not limited to room furnishing features and a number of people in the room simultaneously with the speaker;

iii) a detected physical movement feature—for example, a body-movement feature including but not limited to a feature indicative of hand gestures or other gestures associated with speaking.

According to some embodiments, the at least one feature of the electronic media content includes at least one key words features indicative of a presence and/or absence of key words or key phrases in the spoken content and the information search and/or retrieval is carried out in accordance with the at least one key word feature.

In one example, the key words feature is determined by using a speech-to-text converter for extracting text. The extracted text is then analyzed for the presence of key words or phrases. Alternatively or additionally, the electronic media content may be compared with sound clips that include the key words or phrases.

According to some embodiments, the at least one feature of the electronic media content includes at least one topic category feature—for example, a feature indicative if a topic of a conversation or portion thereof matches one or more topic categories selected from a plurality of topic categories for example, including but not limited to sports (i.e. a conversation related to sports), romance (i.e. a romantic conversation), business (i.e. a business conversation), current events, etc.

According to some embodiments, the at least one feature of the electronic media content includes at least one topic change feature. Exemplary topic change features include but are not limited to a topic change frequency, an impending topic change likelihood, an estimated time until a next topic change, and a time since a previous topic change.

Thus in one example, retrieved information is displayed to a user, and when the conversation topic changes, previously-displayed information associated with a ‘previous topic’ is either removed from the user display and replaced with newer information, or is “scrolled down” or displayed less prominently. The rate at which new information (i.e. in accordance with newer topic of the conversation) replaces older information can be adjusted in accordance with a number of factors, for example, the personality of one or more users (for example, with impulsive users, displayed retrieved information is replaced faster), an emotion associated with one or more words, and other factors.

In some embodiments, the at least one feature of the electronic media content includes at least one feature ‘demographic property’ indicative of and/or derived from at least one demographic property or estimated demographic property (for example, age, gender, etc) of a person involved in the multi-party conversation (for example, a speaker). For example, two users who are over the age of 30 who speak about “Madonna” may be served a link to music clips from Madonna's song in the 1980s, while teenagers may be served a link to a music clip of one of Madonna's more recently released song.

On the other hand, two users with a demographic profile of “devout catholic” may be served an image of the blessed virgin Mary.

Exemplary demographic property features include but are not limited to gender features (for example, related to voice pitch or from hair length or any other gender features), educational level features (for example, related to spoken vocabulary words used), household income feature (for example, related to educational level features and/or key words related to expenditures and/or images of room furnishings), a weight feature (for example, related to overweight/underweight—e.g. related to size in an image or breathing rate where obese individuals or more likely to breath at a faster rate), age features (for example, related to an image of a balding head or gray hair and/or vocabulary choice and/or voice pitch), ethnicity (for example, related to skin color and/or accent and/or vocabulary choice). Another feature that, in some embodiments, may indicate a person's demography is the use (or lack of usage) of certain expressions, including but not limited to profanity. For example, people from certain regions or age groups may be more likely to use profanity (or a certain type), while those from other regions or age groups may be less likely to use profanity (or a certain type).

Not wishing to be bound by theory, it is noted that there are some situations where it is possible to perform ‘on the fly demographic profiling’ (i.e. obtaining demographic features derived from the media content) obviating the need, for example, for ‘explicitly provided’ demographic data for example, from questionnaires or purchased demographic data. This may allow, for example, targeting of more appropriate or more pertinent information.

Demographic property features may be derived from audio and/or video features and/or word content features. Exemplary features from which demographic property features may be derived from include but are not limited to: idiom features (for example, certain ethnic groups or people from certain regions of the United States may tend to use certain idioms), accent features, grammar compliance features (for example, more highly educated people are less likely to make grammatical errors), and sentence length features (for example, more highly educated people are more likely to use longer or more ‘complicated features’).

In one example related to “educational level,” people associated with the more highly educated demographic group are more likely to be served content or links to content from the “New York Times” (i.e. a publication with more “complicated” writing and vocabulary”) while a “less educated user” is served content or links to content from the “New York Post” (i.e. a publication with more “complicated” writing and vocabulary”)

In some embodiments, the at least one feature of the electronic media content includes at least one ‘physiological feature’ indicative of and/or derived from at least one physiological property or estimated demographic property (for example, age, gender, etc) of a person involved in the multi-party conversation (for example, a speaker)—i.e. as derived from the electronic media content of the multi-party conversation.

Exemplary physiological parameters include but are not limited to breathing parameters (for example, breathing rate or changes in breathing rate), a sweat parameters (for example, indicative if a subject is sweating or how much—this may be determined, for example, by analyzing a ‘shininess’ of a subject's skin, a coughing parameter (i.e. a presence or absence of coughing, a loudness or rate of coughing, a regular or irregularity of patterns of coughing), a voice-hoarseness parameter, and a body-twitching parameter (for example, twitching of the entire body due to, for example, chills, or twitching of a given body part—for example, twitching of an eyebrow).

In one example, if the user is “excited” when speaking certain key words, this could cause the user to be served information where the key words spoken when excited are given extra “weight” in any information search or retrieval or display.

In another example, a person may twitch a body part when nervous or lying. If it is assessed that a user or speaker is “lying” this could also influence search results.

In some embodiments, the at least one feature of the electronic media content includes at least one feature ‘background item feature’ indicative of and/or derived from background sounds and/or a background image. It is noted that the background sounds may be transmitted along with the voice of the conversation, and thus may be included within the electronic media content of the conversation.

In one example, if a dog is barking in the background and this is detected, news article about recently-passed local ordinances regulating dog-ownership may be displayed.

The background sound may be determined or identified, for example, by comparing the electronic media content of the conversation with one or more sound clips that include the sound it is desired to detect. These sound clips may thus serve as a ‘template.’

In another example, if a certain furniture item (for example, an ‘expensive’ furniture item) is detected in the background of a video conversation, an item (i.e. good or service) appropriate for the ‘upscale’ income group may be provided.

If it is determined that a user is affluent, then when the user mentions “boat” information about yachts may be displayed to the use. Conversely, a less-affluent user that discusses boats in a conversation may be provided information related to ferry cruises or fishing.

In yet another example, if an image of a crucifix is detected in the background of a video conversation, a news article about the Pope may be provided, or a link to a Catholic blog may be provided.

In some embodiments, the at least one feature of the electronic media content includes at least one feature temporal and/or spatial localization feature indicative of and/or derived from a specific location or time. Thus, in one example, when a Philadelphia-located user (for example, having a phone number in the 215 area code) discussed “sports” he/she is served sports stories (for example, from a newswire) about a recent Phillies or Eagles game, while a Baltimore-located user (for example, having a phone number in the 301 area code) is served sports stories about a recent Orioles or Ravens game.

This localization feature may be determined from the electronic media of the multi-party conversation.

Alternatively or additionally, this localization feature may be determined from data from an external source for example, a GPS and/or mobile phone triangulation.

Another example of an ‘external source’ for localization information is a dialed telephone number. For example, certain area codes or exchanges may be associated (but not always) with certain physical locations.

In some embodiments, the at least one feature of the electronic media content includes at least one ‘historical feature’ indicative of electronic media content of a previous multi-party conversation and/or an earlier time period in the conversation—for example, electronic media content who age is at least, for example, 5 minutes, or 30 minutes, or one hour, or 12 hours, or one day, or several times, or a week, or several weeks.

In some embodiments, the at least one feature of the electronic media content includes at least one ‘deviation feature.’ Exemplary deviation features of the electronic media content of the multi-party conversation include but are not limited to:

a) historical deviation features—i.e. a feature of a given subject or person that changes temporally so that a given time, the behavior of the feature differs from its previously-observed behavior. Thus, in one example, a certain subject or individual usually speaks slowly, and at a later time, this behavior ‘deviates’ when the subject or individual speaks quickly. In another example, a typically soft-spoken individual speaks with a louder voice.

In another example, an individual who 3 months ago was observed (e.g. via electronic media content) to be of average or above-average weight is obese. This individual may be served a Wikipedia link about weight-loss. In contrast, a user who is consistently obese may not be served the link in order not to “annoy” the user.

In another example, a person who is normally polite may become angry and rude—this may an example of ‘user behavior features.’

b) inter-subject deviation features—for example, a ‘well-educated’ person associated with a group of lesser educated persons (for example, speaking together in the same multi-party conversation), or a ‘loud-spoken’ person associated with a group of ‘soft-spoken’ persons, or ‘Southern-accented’ person associated with a group of persons with Boston accents, etc. If distinct conversations are recorded, then historical deviation features associated with a single conversation are referred to as intra-conversation deviation features, while historical deviation features associated with distinct conversations are referred to as inter-conversation deviation features.

c) voice-property deviation features—for example, an accent deviation feature, a voice pitch deviation feature, a voice loudness deviation feature, and/or a speech rate deviation feature. This may related to user-group deviation features as well as historical deviation features.

d) physiological deviation features—for example, breathing rate deviation features, weight deviation features—this may related to user-group deviation features as well as historical deviation features.

e) vocabulary or word-choice deviation features—for example, profanity deviation features indicating use of profanity—this may related to user-group deviation features as well as historical deviation features.

f) person-versus-physical-location—for example, a person with a Southern accent whose location is determined to be in a Northern city (e.g. Boston) might be provided with a hotel coupon

In some embodiments, the at least one feature of the electronic media content includes at least one ‘person-recognition feature.’ This may be useful, for example, for providing pertinent retrieved information targeted for a specific person. Thus, in one example, the person-recognition feature allows access to a database of person-specific data where the person-recognition feature functions, at least in part, as a ‘key’ of the database. In one example, the ‘data’ may be previously-provided data about the person, for example, demographic data or other data, that is provided in any manner, for example, derived from electronic media of a previous conversation, or in any other manner.

In some embodiments, this may obviate the need for users to explicitly provide account information and/or to log in order to receive ‘personalized’ retrieved information. Thus, in one example, the user simply uses the service, and the user's voice is recognized from a voice-print. Once the system recognizes the specific user, it is possible to present retrieved information in accordance with previously-stored data describing preferences of the specific user.

Exemplary ‘person-recognition’ features include but are not limited to biometric features (for example, voice-print or facial features) or other person visual appearance features, for example, the presence or absence of a specific article of clothing.

It is noted that the possibility of recognizing a person via a ‘person-recognition’ feature does not rule out the possibility of using more ‘conventional’ techniques—for example, logins, passwords, PINs, etc.

In some embodiments, the at least one feature of the electronic media content includes at least one ‘person-influence feature.’ Thus, it is recognized that during certain conversations, certain individuals may have more influence than others—for example, in a conversation between a boss and an employee, the boss may have more influence and may function as a so-called gatekeeper. For example, if one party of the conversation makes a certain statement, and this statement appears to influence one or more other parties of the conversation, the ‘influencing statement’ may be assigned more importance. For example, if party ‘A’ says ‘we should spend more money on clothes’ and party ‘B’ responds by saying ‘I agree’ this could imbue party A's statement with additional importance, because it was an ‘influential statement.’

In one example, a user has several conversations in one day. The first conversation is with an “influential person” who may be “important” for example, a client/boss to whom the user of a device shows deference. When the conversation with the “important” person begins, previous search results may be cleared from a display screen or scrolled down, and replaced with search results that relate to the conversation with “important” person. Subsequently, the user may speak with a less “influential” person—for example, a child. In this example, during the second subsequent conversation, previously-display retrieved information (for example, retrieved in accordance with the first conversation) is not replaced with information retrieved from the second conversation.

In some embodiments, the retrieval and/or presentation of information includes presenting information to a first individual (for example, person ‘A’) in accordance with one or more feature of media content from a second individual different from the first individual (for example, person ‘B’).

Apparatus for Retrieving Information

Some embodiments of the present invention provide apparatus for retrieving and presenting information. The apparatus may be operative to implement any method or any step of any method disclosed herein. The apparatus may be implemented using any combination of software and/or hardware.

The data storage may be implemented using any combination of volatile and/or non-volatile memory, and may reside in a single device or reside on a plurality devices either locally or over a wide area.

The aforementioned apparatus may be provided as a single client device (for example, as a handset or laptop or desktop configured to present retrieved information in accordance with the electronic media content). In this example, the ‘data storage’ is volatile and/or non-volatile memory of the client device—for example, where outgoing and incoming content is digitally stored in the client device or a peripheral storage device of the client device.

Alternatively or additionally, the apparatus may be distributed on a plurality of devices for example with a ‘client-server’ architecture.

These and further embodiments will be apparent from the detailed description and examples that follow.

### BRIEF DESCRIPTION OF THE DRAWINGS

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

FIGS. 1A-1C describe exemplary use scenarios.

FIG. 2A-2D, 4, 5A-5C provide flow charts of exemplary techniques for locating, retrieving and/or presenting information related to electronic media content of a multi-party conversation.

FIG. 3 describes an exemplary technique for computing one or more features of electronic media content including voice content.

FIG. 6 provides a block diagram of an exemplary system for retrieving and presenting information in according with some embodiments of the present invention.

FIG. 7 describes an exemplary system for providing electronic media content of a multi-party conversation.

FIGS. 8-14 describes exemplary systems for computing various features.

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for information retrieval and presentation is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

Embodiments of the present invention relate to a technique for retrieving and displaying information in accordance with the context and/or content of voice content including but not limited to voice content transmitted over a telecommunications network in the context of a multiparty conversation.

Certain examples of related to this technique are now explained in terms of exemplary use scenarios. After presentation of the use scenarios, various embodiments of the present invention will be described with reference to flow-charts and block diagrams. It is noted that the use scenarios relate to the specific case where the retrieved information is presented ‘visually’ by the client device. In other examples, the information may be presented by audio means—for example, before, during or following a call or conversation.

Also, it is noted that the present use scenarios and many other examples relate to the case where the multi-party conversation is transmitted via a telecommunications network (e.g. circuit switched and/or packet switched). In other example, two or more people are conversing ‘in the same room’ and the conversation is recorded by a single microphones or plurality of microphones (and optionally one or more cameras) deployed ‘locally’ without any need for transmitting content of the conversation via a telecommunications network.

### Use Scenario 1

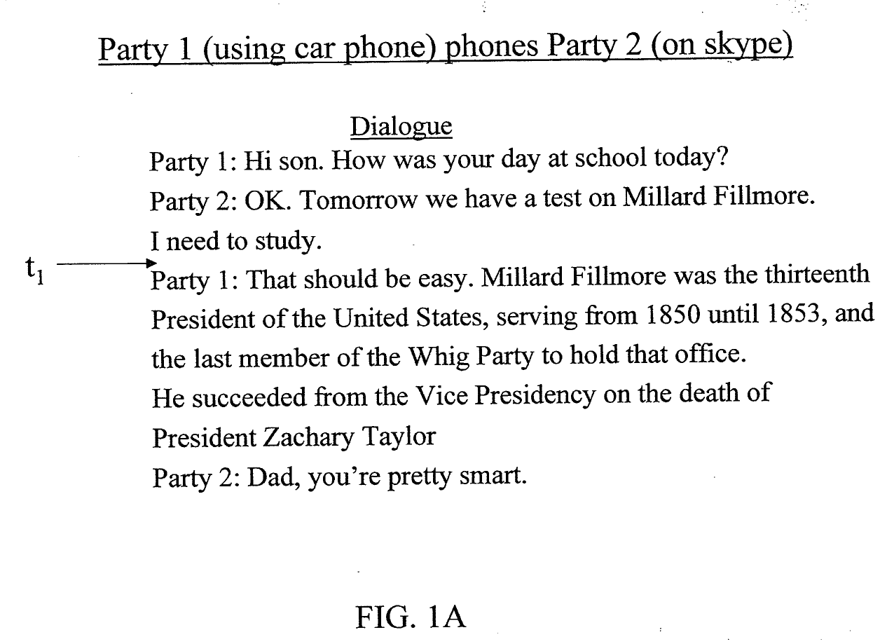

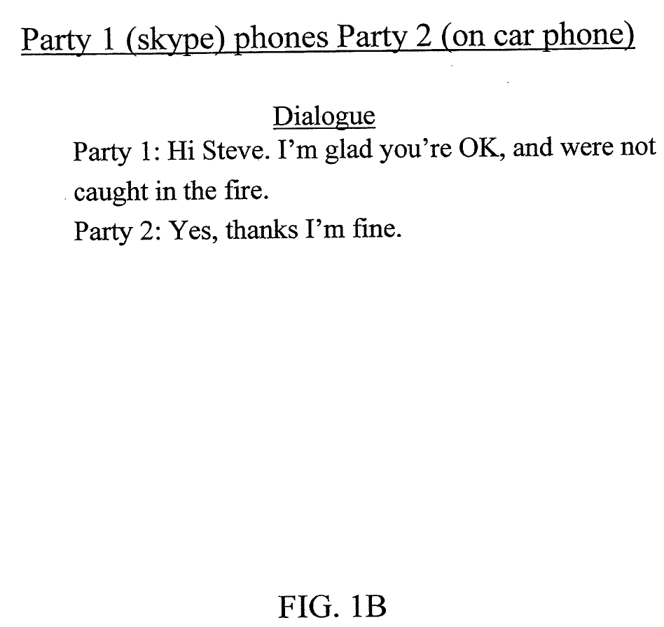

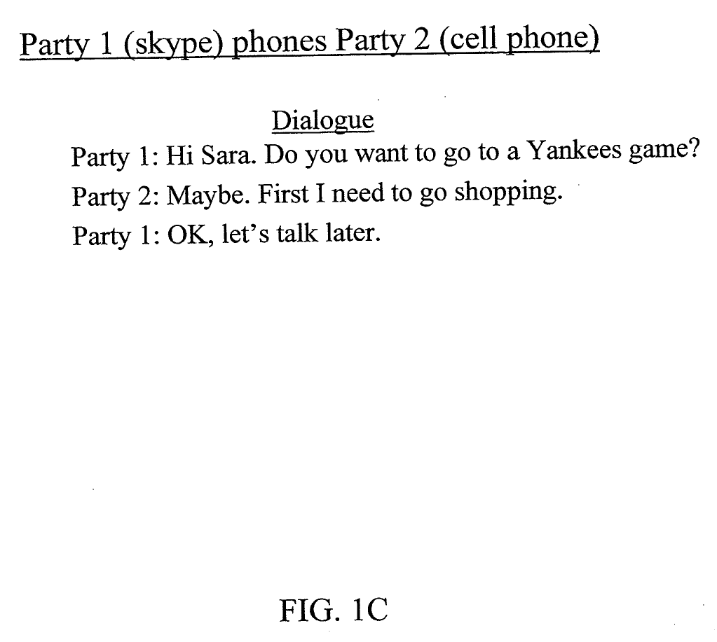

### Example of FIG. 1A

According to this scenario, a first user (i.e. ‘party 1’) of a “car phone” (i.e. a mobile phone mounted in a car, for example, in proximity of an onboard navigator system) a second user (i.e. ‘party 2’) using VOIP software residing on the desktop, such as Skype® software.

In this example, at time t=t1, retrieved information is served to party 1 in accordance with content of the conversation. In the example of FIG. 1A, when Party 2 mentions “Millard Fillmore,” information about Millard Fillmore (for example, from a search engine or Wikipedia article) is retrieved and displayed on a client device associated with “party 1”—either the “small screen” of “Party 1”'s car-mounted cellphone or the “larger screen” of party 1's onboard navigator device.

It is noted that in the Example of FIG. 1A, there is no need for “Party 1” to provide any search query whatsoever—a conversation is monitored that is not directed to the entity doing the monitoring but rather, the words of Party 1 are directed exclusively to other co-conversationalist(s)—in this case Party 2, and the words of Party 2 are directed exclusively to Party 1.

In the example of FIG. 1A, Party 2 “knows” that Party 1 is driving and cannot key in a search query, for example a standard Internet search engine. Thus, when party 1 unexpectedly knows extensive information about Millard Fillmore (i.e. a rather exotic topic), Party 1 succeeds in surprising party 1.

It is noted the decision to search on “Millard Fillmore” rather than “school” may be made using natural language processing techniques—for example, language-model based techniques discussed below.

### Use Scenario 2

### Example of FIG. 1B

In this example, party 1 is located in Cleveland and party 2 is located in Boston. Party 2 driving in a region of the city where a building was recently on fire. They are discussing the building fire. In the example of FIG. 1B, after the word “fire” is meant, a news story about a fire is displayed on a screen of a user 1. The fire is not a major fire, and at the time, a number of small fires are being handled in different cities throughout the United States. Thus, a certain amount of “disambiguation” is required in order to serve information about the “correct fire.”

In the example of FIG. 1B, it is possible to detect the location of party 2 (i.e. Boston) (for example, using a phone number or other technique) and to serve the “correct” local news story to the device of party 1.

### Use Scenario 3

### Example of FIG. 1C

In this example, party 1 proposes going go a Yankees game. Party 2 does not mention anything specific about the Yankees. Nevertheless, information about the Yankees (for example, an article about the history of the Yankees, or a news story about their latest game) is retrieved and served to the client terminal device of party 2. This is one example of information being retrieved and served (i.e. to the “cellphone” of party 2) in accordance with “incoming” (i.e. incoming to the “cellphone” client terminal device of Party 2) electronic media content of the multi-party conversation.

### SOME BRIEF DEFINITIONS

As used herein, ‘providing’ of media or media content includes one or more of the following: (i) receiving the media content (for example, at a server cluster comprising at least one cluster, for example, operative to analyze the media content and/or at a proxy); (ii) sending the media content; (iii) generating the media content (for example, carried out at a client device such as a cell phone and/or PC); (iv) intercepting; and (v) handling media content, for example, on the client device, on a proxy or server.

As used herein, a ‘multi-party’ voice conversation includes two or more parties, for example, where each party communicated using a respective client device including but not limited to desktop, laptop, cell-phone, and personal digital assistant (PDA).

In one example, the electronic media content from the multi-party conversation is provided from a single client device (for example, a single cell phone or desktop). In another example, the media from the multi-party conversation includes content from different client devices.
Similarly, in one example, the media electronic media content from the multi-party conversation is from a single speaker or a single user. Alternatively, in another example, the media electronic media content from the multi-party conversation is from multiple speakers.
The electronic media content may be provided as streaming content. For example, streaming audio (and optionally video) content may be intercepted, for example, as transmitted a telecommunications network (for example, a packet switched or circuit switched network). Thus, in some embodiments, the conversation is monitored on an ongoing basis during a certain time period.
Alternatively or additionally, the electronic media content is pre-stored content, for example, stored in any combination of volatile and non-volatile memory.

As used herein, ‘presenting of retrieved information in accordance with a least one feature’ includes one or more of the following:

i) configuring a client device (i.e. a screen of a client device) to display the retrieved information such that display of the client device displays the retrieved information in accordance with the feature of media content. This configuring may be accomplished, for example, by displaying the retrieved information using an email client and/or a web browser and/or any other client residing on the client device;

ii) sending or directing or targeting an the retrieved information to a client device in accordance with the feature of the media content (for example, from a client to a server, via an email message, an SMS or any other method);

### DETAILED DESCRIPTION OF BLOCK DIAGRAMS AND FLOW CHARTS

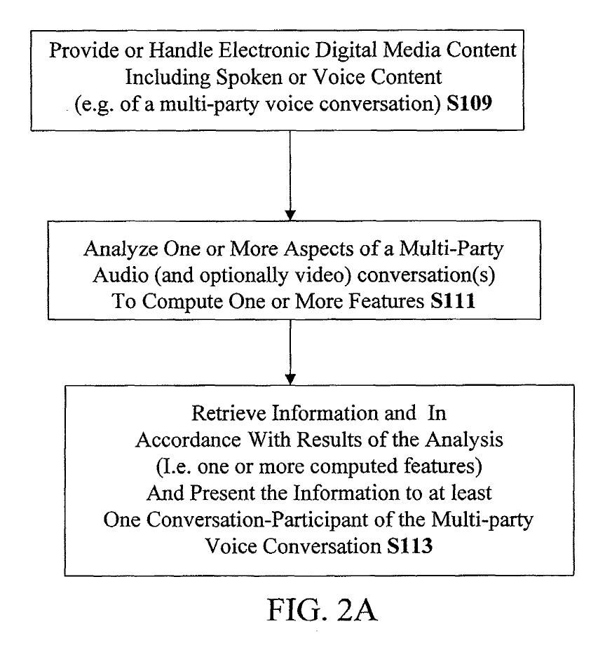

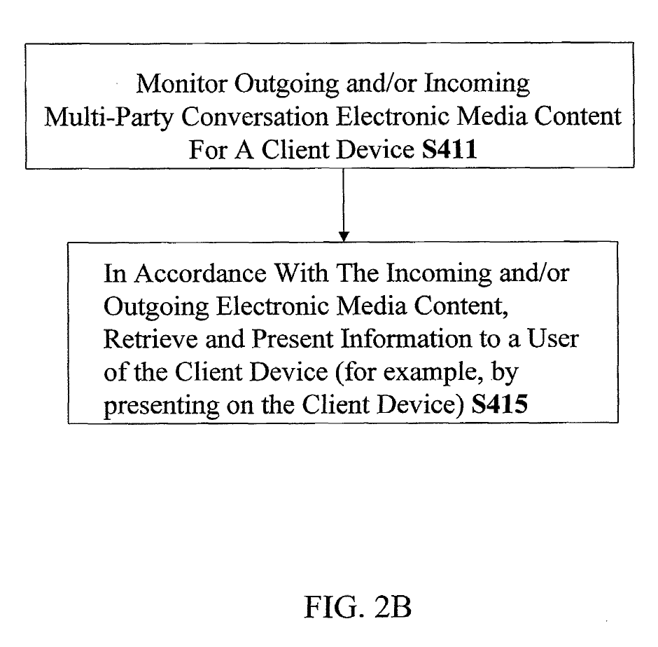

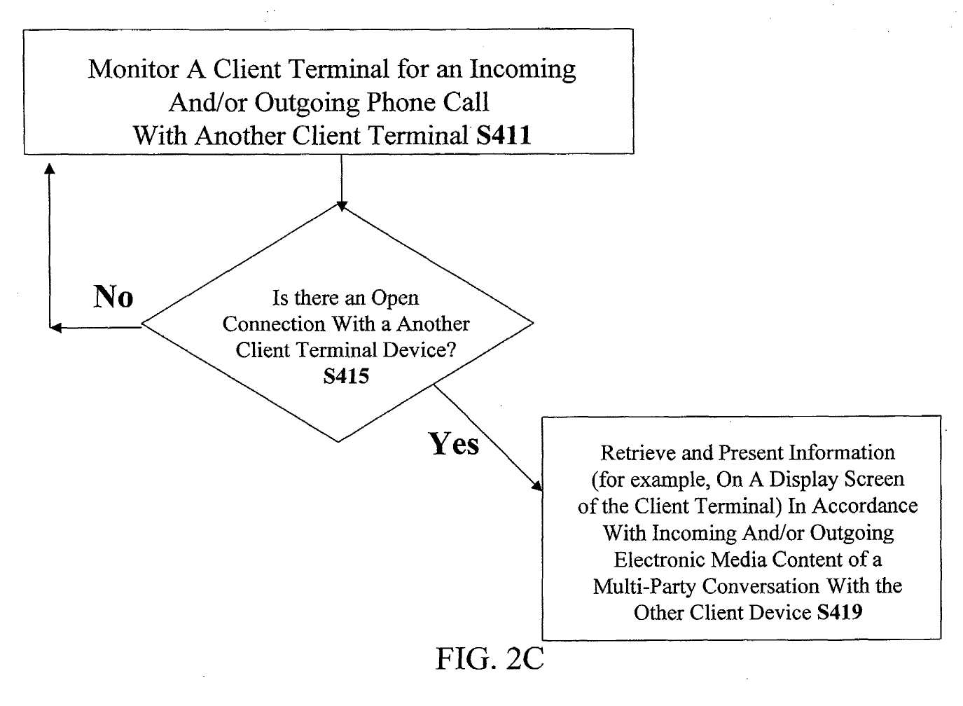

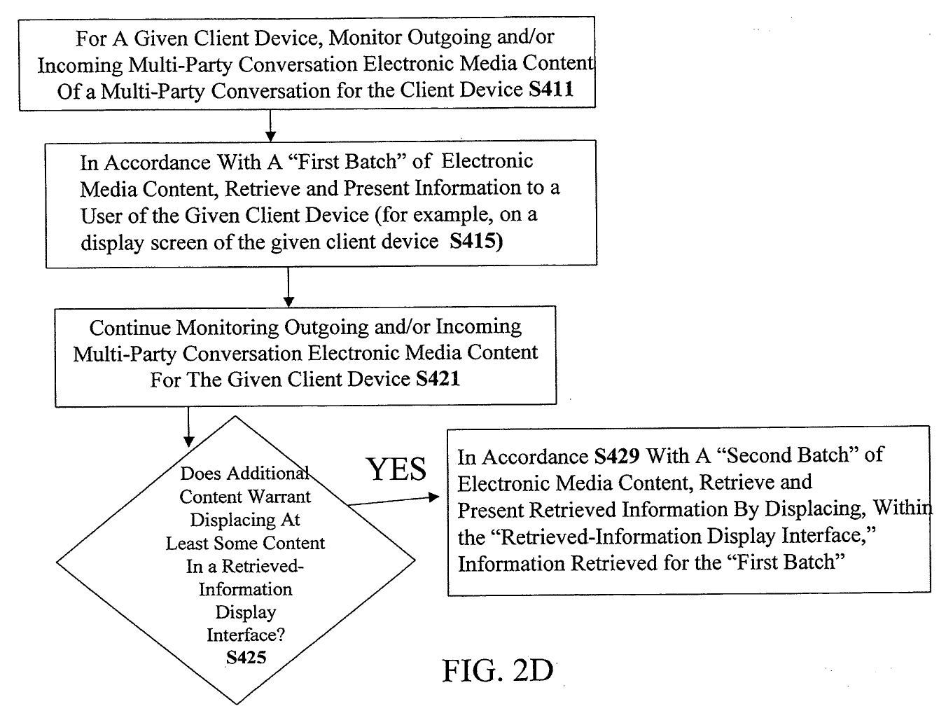

FIG. 2A refers to an exemplary technique for retrieving and presenting information in accordance with content of a multi-party conversation.

In step S109, electronic digital media content including spoken or voice content (e.g. of a multi-party audio conversation) is provided—e.g. received and/or intercepted and/or handled.

In step S111, one or more aspects of electronic voice content (for example, content of multi-party audio conversation are analyzed), or context features are computed. In one example, the words of the conversation are extracted from the voice conversation and the words are analyzed, for example, for a presence of key phrases.

In another example, discussed further below, an accent of one or more parties to the conversation is detected. If, for example, one party has a ‘Texas accent’ then this increases a likelihood that the party will receive (for example, on her terminal such as a cellphone or desktop) information from a Texas-based online newspaper or magazine.

In another example, the multi-party conversation is a ‘video conversation’ (i.e. voice plus video). In a particular example, if a conversation participant is wearing, for example, a hat or jacket associated with a certain sports team (for example, a particular baseball team), and if that sports team is scheduled an “away game” in a different city, a local weather forecast or traffic forecast associated with the game may be presented either to the “fan” or to a co-conversationalist (for example, using a different client terminal device) who could then “impress” the “fan” with his knowledge.

In step S113, one or more operations are carried out to retrieve and present information in accordance with results of the analysis of step S111.

The information may be retrieved from any source, including but not limited to online search engines, news services (for example, newswires or “news sites” like www.cnn.com or www.nytimes.com), images or video banks, RSS feeds, weather or traffic forecasts, Youtube® clips, sports statistics, Diugg, social editing sites, music banks, shopping sights such as Amazon, Deel.icio.us and blogs. The information source may be local (for example, the local file system of a desktop computer or PDA) and/or may be remote (for example, a remote “Internet” search engine accessible via the Internet).

Although advertisement information may be served together with the retrieved information, in many examples, the retrieved information includes information other than advertisement such as: Wikipedia entries, entries from social networks (such as dating sites, myspace, LinkedIn, etc), news articles, blohs, video or audio clips, or just about any form of information.

FIG. 2B presents a flow-chart of a technique where outgoing and/or incoming content is monitored S411, and in accordance with the content, information is retrieved and presented S415. One example of how this is accomplished in accordance with “incoming content” was discussed with reference to FIG. 1C.

FIG. 2C provides a flow-chart wherein a terminal device is monitored S411 for an incoming and/or outgoing call with another client terminal device. In the event that an incoming and/or outgoing call or a “connection” is detected S415, information is retrieved in accordance with incoming and/or outgoing content of the multi-party conversation and presented.

It is known that a conversation can “flow” and in many conversations, multiple topics are discussed. FIG. 2D provides a flow chart of an exemplary technique where: (i) a first information retrieval and presentation is carried out in accordance with a first “batch” of content or words (S411 and S415); and (ii) when the topic changes or another event occurs S425 (for example, a speaker gets excited about something, raises his or her voice, looks up, repeats a phrase, etc—for example, beyond some threshold), information may be retrieved and presented (i.e. by displacing the previously-retrieved information from the first batch of electronic media content) in accordance with content 8429 of a “second batch” of content or words.

In one example, the “earlier” information may be scrolled down. Alternatively or additionally, a “link” or interface element “pointing” to most recent content may be re-configured to, upon user invocation, provide the retrieved information for the “second batch” of content rather than the “first batch” of content, after, for example, the topic has changed and/or the user or conversation-participant has indicated a particular emotion or body language, etc.

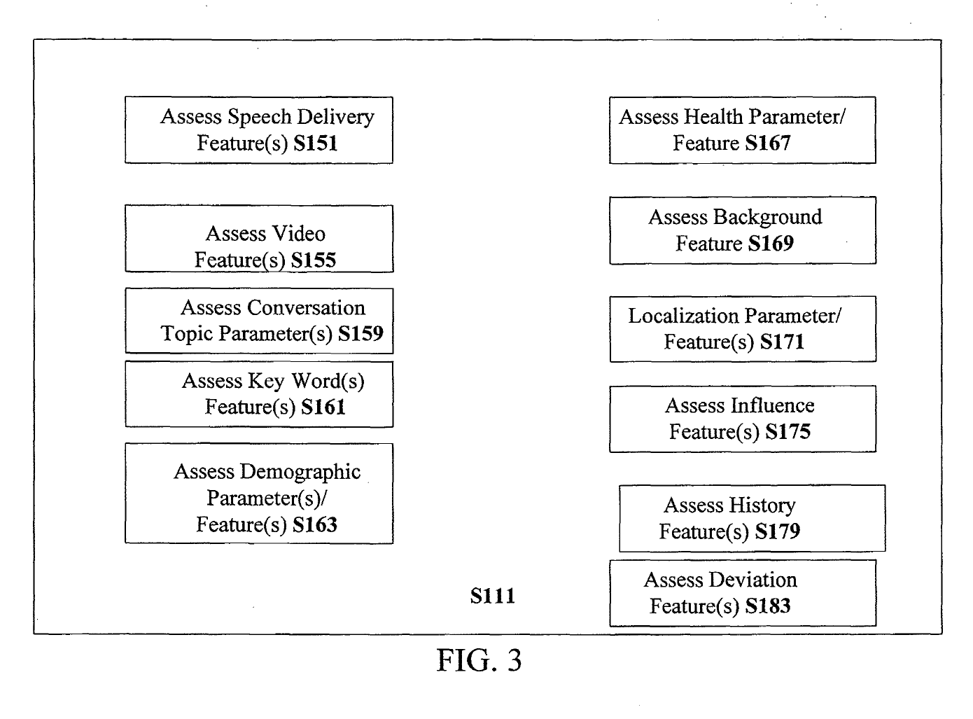

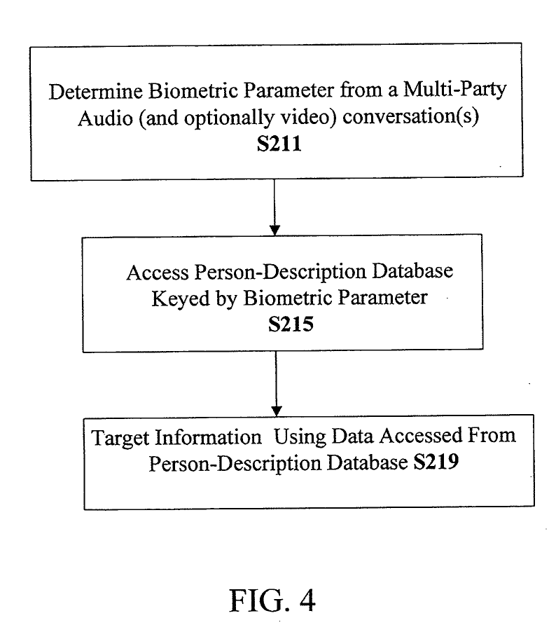

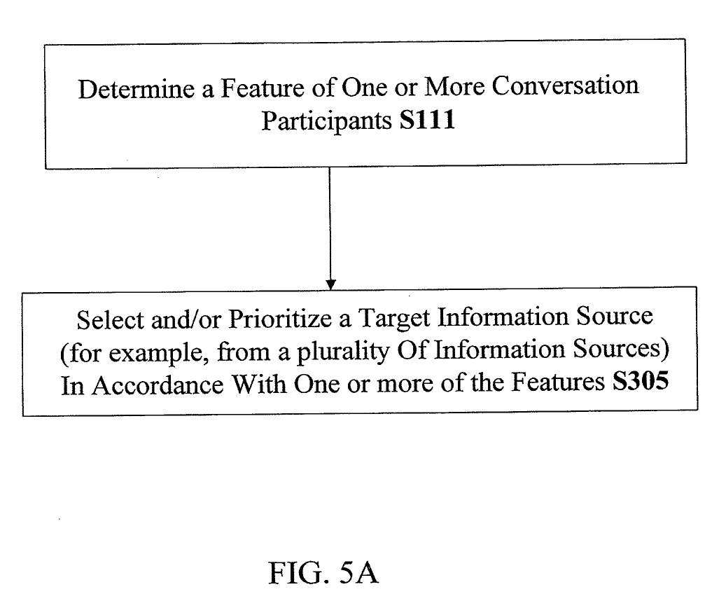

Obtaining a Demographic Profile of a Conversation Participant from Audio and/or Video Data Relating to a Multi-Party Voice and Optionally Video Conversation (with reference to FIG. 3)

FIG. 3 provides exemplary types of features that are computed or assessed S111 when analyzing the electronic media content. These features include but are not limited to speech delivery features S151, video features 8155, conversation topic parameters or features S159, key word(s) feature S161, demographic parameters or features S163, health or physiological parameters of features S167, background features S169, localization parameters or features S175, influence features S175, history features S179, and deviation features S183.

Thus, in some embodiments, by analyzing and/or monitoring a multi-party conversation (i.e. voice and optionally video), it is possible to assess (i.e. determine and/or estimate) S163 if a conversation participant is a member of a certain demographic group from a current conversation and/or historical conversations. This information may then be used to more effectively retrieve and present “pertinent” information to the user and/or an associate of the user.

Relevant demographic groups include but are not limited to: (i) age; (ii) gender; (iii) educational level; (iv) household income; (v) ethnic group and/or national origin; (vi) medical condition.

(i) age/(ii) gender—in some embodiments, the age of a conversation participant is determined in accordance with a number of features, including but not limited to one or more of the following: speech content features and speech delivery features.
A) Speech content features—after converting voice content into text, the text may be analyzed for the presence of certain words or phrases. This may be predicated, for example, on the assumption that teenagers use certain slang or idioms unlikely to be used by older members of the population (and vice-versa).
B) Speech delivery features—in one example, one or more speech delivery features such as the voice pitch or speech rate (for example, measured in words/minute) of a child and/or adolescent may be different than and speech delivery features of an young adult or elderly person.

The skilled artisan is referred to, for example, US 20050286705, incorporated herein by reference in its entirety, which provides examples of certain techniques for extracting certain voice characteristics (e.g. language/dialect/accent, age group, gender).

In one example related to video conversations, the user's physical appearance can also be indicative of a user's age and/or gender. For example, gray hair may indicate an older person, facial hair may indicate a male, etc.

Once an age or gender of a conversation participant is assessed, it is possible to target retrieved information to the participant (or an associated thereof) accordingly.

(ii) educational level—in general, more educated people (i.e. college educated people) tend to use a different set of vocabulary words than less educated people.

Information retrieval and/or presentation can be customized using this demographic parameter as well. For example, if it assumed that a conversationalist is college educated people, the n

(iv) ethnic group and/or national origin—this feature also may be assessed or determined using one or more of speech content features and speech delivery features.

(v) number of children per household this may be observable from background ‘voices’ or noise or from a background image.

In one example, if background noise indicative of a present of children is detected in the background (for example, for voice pitch or a baby crying), then “child-oriented” content (for example, a link to a Sesame Street clip) or “parent-oriented content” (for example, an article from Parenting magazine online).

Thus, in one example, if two people are discussing movies, each on a respective cell phone, and a baby crying is detected in the background for the first “cell phone” then the first user may be served an article about popular movies for young children.

If the conversation then shifts to the topic of vacations, and a dog barking is detected in the background for the second “cell phone” then the second user on the second cell phone may be served an article about popular “pet-friendly” vacation destinations.

One example of ‘speech content features’ includes slang or idioms that tend to be used by a particular ethnic group or non-native English speakers whose mother tongue is a specific language (or who come from a certain area of the world).

One example of ‘speech delivery features’ relates to a speaker's accent. The skilled artisan is referred, for example, to US 2004/0096050, incorporated herein by reference in its entirety, and to US 2006/0067508, incorporated herein by reference in its entirety.

(vi) medical condition—In some embodiments, a user's medical condition (either temporary or chronic) may be assessed in accordance with one or more audio and/or video features.

In one example, breathing sounds may be analyzed, and breathing rate may be determined. This may be indicative of whether or not a person has some sort of respiratory ailment, and data from a medical database could be presented to the user.

Alternatively, breathing sounds may determine user emotions and/or user interest in a topic.

Storing Biometric Data (for Example, Voice-Print Data) and Demographic Data (with Reference to FIG. 4)

Sometimes it may be convenient to store data about previous conversations and to associate this data with user account information. Thus, the system may determine from a first conversation (or set of conversations) specific data about a given user with a certain level of certainty.

Later, when the user engages in a second multi-party conversation, it may be advantageous to access the earlier-stored demographic data in order to provide to the user pertinent information. Thus, there is no need for the system to re-profile the given user.

In another example, the earlier demographic profile may be refined in a later conversation by gathering more ‘input data points.’

In some embodiments, the user may be averse to giving ‘account information’—for example, because there is a desire not to inconvenience the user.

Nevertheless, it may be advantageous to maintain a ‘voice print’ database which would allow identifying a given user from his or her ‘voice print.’

Recognizing an identity of a user from a voice print is known in the art—the skilled artisan is referred to, for example, US 2006/0188076; US 2005/0131706; US 2003/0125944; and US 2002/0152078 each of which is incorporated herein by reference in entirety

Thus, in step S211 content (i.e. voice content and optionally video content) if a multi-party conversation is analyzed and one or more biometric parameters or features (for example, voice print or face ‘print’) are computed. The results of the analysis and optionally demographic data are stored and are associated with a user identity and/or voice print data.

During a second conversation, the identity of the user is determined and/or the user is associated with the previous conversation using voice print data based on analysis of voice and/or video content S215. At this point, the previous demographic information of the user is available.

Optionally, the demographic profile is refined by analyzing the second conversation.

Techniques for Retrieving and/or Presenting Information in Accordance with a Multi-Party Conversation

FIG. 5A provides a flow chart of an exemplary technique for retrieving and providing information. In the example of FIG. 5A, certain words are given “weights” in the information retrieval according to one or more features of a conversation participant. For example, if it is determined that a given conversation-participant is “dominant” in the conversation (i.e. either from a personality profile or from the interaction between conversation-participants), words spoken by this participant may be given a greater weight in information retrieval or search.

In another example, words spoken excitedly and/or with certain body language may be given greater weight.

FIG. 5B relates to a technique where a term disambiguation S309 may be carried out in accordance with one or more features of a conversation participant. For example, if it assessed that a person is an avid investor or computer enthusiast, then the word “apple” may be handled by retrieving information related to Apple Computer.

Another example relates to the word Madonna—this could refer either to the “Virgin Mary” to a singer. If it is assessed that a conversation participant is an avid catholic, it is more likely the former. If it is assessed that a conversation participant is likes pop-music (for example, from background sounds, age demographics, slang, etc), then Madonna is more likely to refer to the singer.

In the exemplary technique of FIG. 5C, words are given greater “weight” or priority in accordance with body language and/or speech delivery features.

Discussion of Exemplary Apparatus

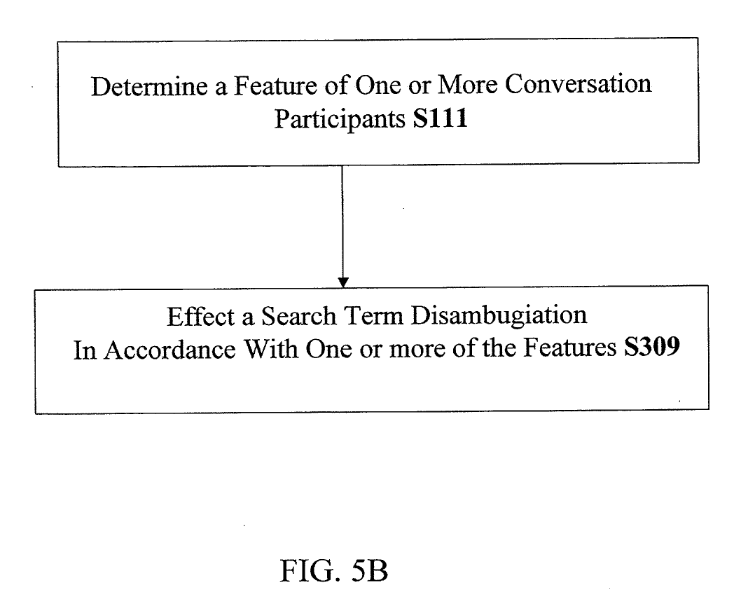

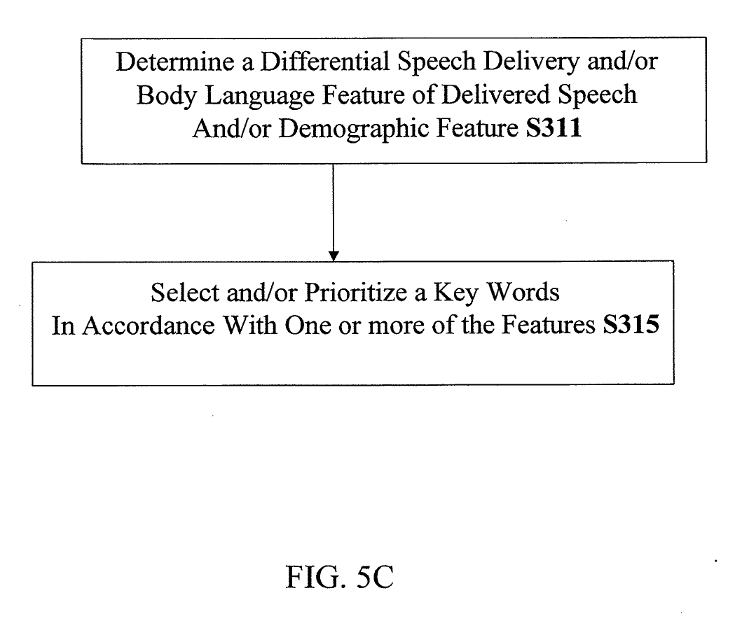

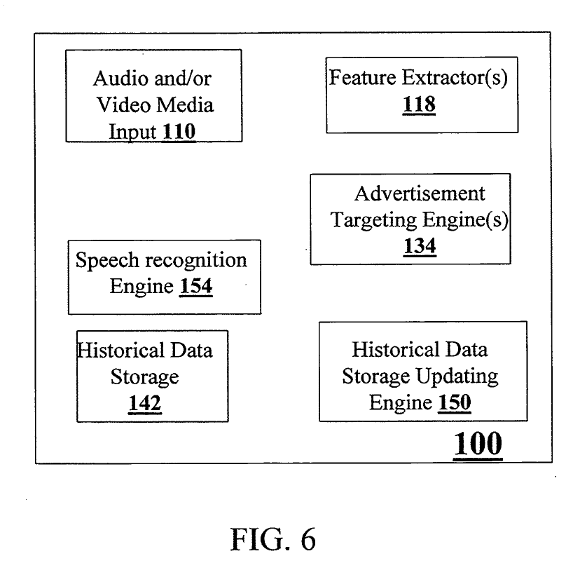

FIG. 6 provides a block diagram of an exemplary system 100 for retrieval and presentation of information in according with some embodiments of the present invention. The apparatus or system, or any component thereof may reside on any location within a computer network (or single computer device) i.e. on the client terminal device 10, on a server or cluster of servers (not shown), proxy, gateway, etc. Any component may be implemented using any combination of hardware (for example, non-volatile memory, volatile memory, CPUs, computer devices, etc) and/or software—for example, coded in any language including but not limited to machine language, assembler, C, C++, Java, C#, Perl etc.

The exemplary system 100 may an input 110 for receiving one or more digitized audio and/or visual waveforms, a speech recognition engine 154 (for converting a live or recorded speech signal to a sequence of words), one or more feature extractor(s) 118, a historical data storage 142, and a historical data storage updating engine 150.

Exemplary implementations of each of the aforementioned components are described below.

It is appreciated that not every component in FIG. 6 (or any other component described in any figure or in the text of the present disclosure) must be present in every embodiment. Any element in FIG. 6, and any element described in the present disclosure may be implemented as any combination of software and/or hardware. Furthermore, any element in FIG. 6 and any element described in the present disclosure may be either reside on or within a single computer device, or be a distributed over a plurality of devices in a local or wide-area network.

Audio and/or Video Input 110

In some embodiments, the media input 110 for receiving a digitized waveform is a streaming input. This may be useful for ‘eavesdropping’ on a multi-party conversation in substantially real time. In some embodiments, ‘substantially real time’ refers to refer time with no more than a predetermined time delay, for example, a delay of at most 15 seconds, or at most 1 minute, or at most 5 minutes, or at most 30 minutes, or at most 60 minutes.

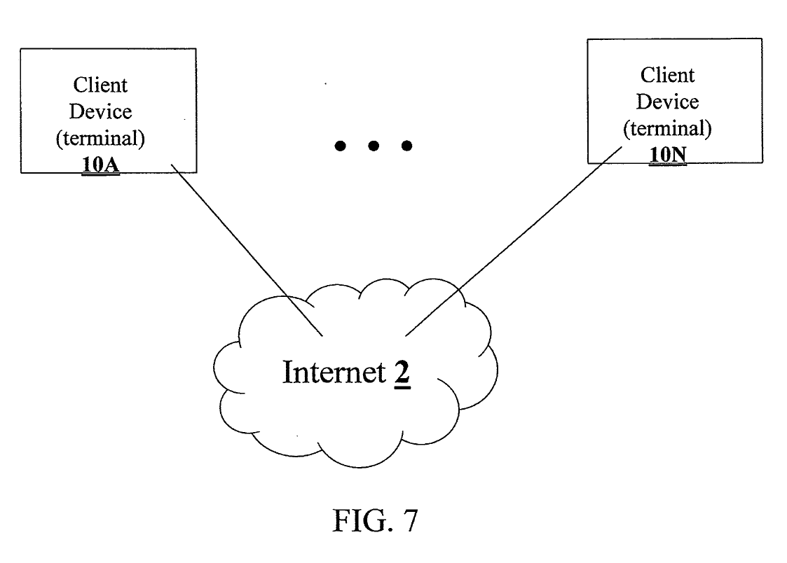

FIG. 7, a multi-party conversation is conducted using client devices or communication terminals 10 (i.e. N terminals, where N is greater than or equal to two) via the Internet 2. In one example, VOIP software such as Skype® software resides on each terminal 10.

In one example, ‘streaming media input’ 110 may reside as a ‘distributed component’ where an input for each party of the multi-party conversation resides on a respective client device 10. Alternatively or additionally, streaming media signal input 110 may reside at least in part ‘in the cloud’ (for example, at one or more servers deployed over wide-area and/or publicly accessible network such as the Internet 20). Thus, according to this implementation, and audio streaming signals and/or video streaming signals of the conversation (and optionally video signals) may be intercepted as they are transmitted over the Internet.

In yet another example, input 110 does not necessarily receive or handle a streaming signal. In one example, stored digital audio and/or video waveforms may be provided stored in non-volatile memory (including but not limited to flash, magnetic and optical media) or in volatile memory.

It is also noted, with reference to FIG. 7, that the multiparty conversation is not required to be a VOIP conversation. In yet another example, two or more parties are speaking to each other in the same room, and this conversation is recorded (for example, using a single microphone, or more than one microphone). In this example, the system 100 may include a ‘voice-print’ identifier (not shown) for determining an identity of a speaking party (or for distinguishing between speech of more than one person).

In yet another example, at least one communication device is a cellular telephone communicating over a cellular network.

In yet another example, two or more parties may converse over a ‘traditional’ circuit-switched phone network, and the audio sounds may be streamed to information retrieval and presentation system 100 and/or provided as recording digital media stored in volatile and/or non-volatile memory.

Feature Extractor(s) 118

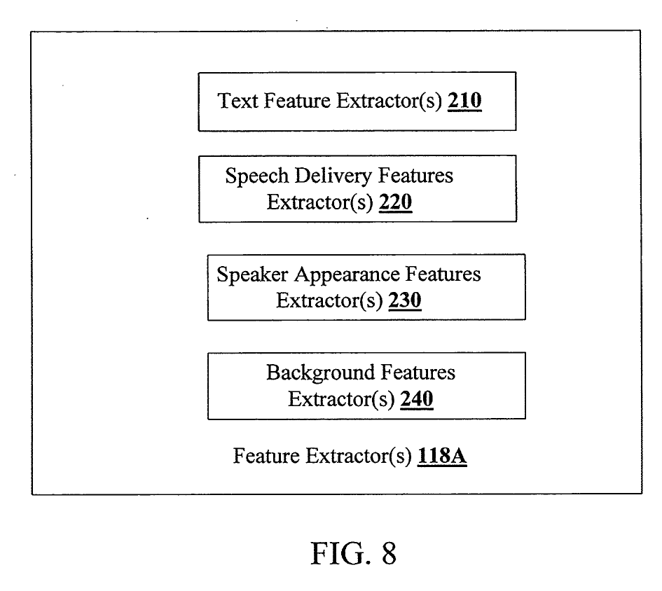

FIG. 8 provides a block diagram of several exemplary feature extractor(s)—this is not intended as comprehensive but just to describe a few feature extractor(s). These include: text feature extractor(s) 210 for computing one or more features of the words extracted by speech recognition engine 154 (i.e. features of the words spoken); speech delivery features extractor(s) 220 for determining features of how words are spoken; speaker visual appearance feature extractor(s) 230 (i.e. provided in some embodiments where video as well as audio signals are analyzed); and background features (i.e. relating to background sounds or noises and/or background images).

It is noted that the feature extractors may employ any technique for feature extraction of media content known in the art, including but not limited to heuristically techniques and/or ‘statistical AI’ and/or ‘data mining techniques’ and/or ‘machine learning techniques’ where a training set is first provided to a classifier or feature calculation engine. The training may be supervised or unsupervised.

Exemplary techniques include but are not limited to tree techniques (for example binary trees), regression techniques, Hidden Markov Models, Neural Networks, and meta-techniques such as boosting or bagging. In specific embodiments, this statistical model is created in accordance with previously collected “training” data. In some embodiments, a scoring system is created. In some embodiments, a voting model for combining more than one technique is used.

Appropriate statistical techniques are well known in the art, and are described in a large number of well known sources including, for example, Data Mining: Practical Machine Learning Tools and Techniques with Java Implementations by lan H. Witten, Eibe Frank; Morgan Kaufmann, October 1999), the entirety of which is herein incorporated by reference.

It is noted that in exemplary embodiments a first feature may be determined in accordance with a different feature, thus facilitating ‘feature combining.’

In some embodiments, one or more feature extractors or calculation engine may be operative to effect one or more ‘classification operations’—e.g. determining a gender of a speaker, age range, ethnicity, income, and many other possible classification operations.

Each element described in FIG. 8 is described in further detail below.

Text Feature Extractor(s) 210

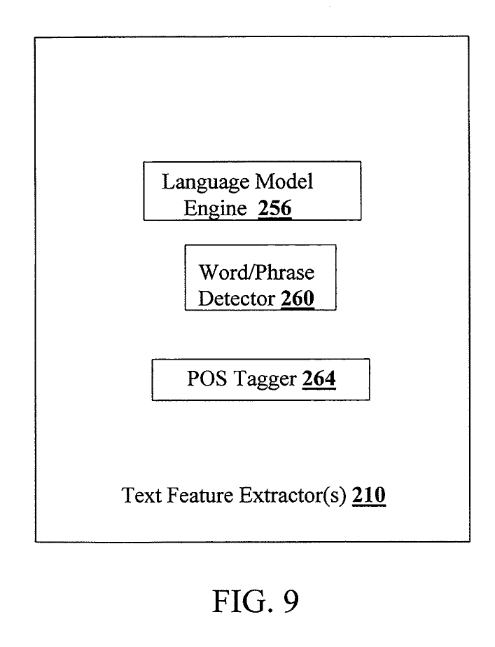

FIG. 9 provides a block diagram of exemplary text feature extractors. Thus, certain phrases or expressions spoken by a participant in a conversation may be identified by a phrase detector 260.

In one example, when a speaker uses a certain phrase, this may indicate a current desire or preference. For example, if a speaker says “I am quite hungry” this may indicate that a food product add should be sent to the speaker.

In another example, a speaker may use certain idioms that indicate general desire or preference rather than a desire at a specific moment. For example, a speaker may make a general statement regarding a preference for American cars, or a professing love for his children, or a distaste for a certain sport or activity. These phrases may be detected and stored as part of a speaker profile, for example, in historical data storage 142.

The speaker profile built from detecting these phrases, and optionally performing statistical analysis, may be useful for present or future provisioning of ads to the speaker or to another person associated with the speaker.

The phrase detector 260 may include, for example, a database of pre-determined words or phrases or regular expressions.

In one example, it is recognized that the computational cost associated with analyzing text to determine the appearance of certain regular phrases (i.e. from a pre-determined set) may increase with the size of the set of phrases.

Thus, the exact set of phrases may be determined by various business considerations. In one example, certain sponsors may ‘purchase’ the right to include certain phrases relevant for the sponsor's product in the set of words or regular expressions.

In another example, the text feature extractor(s) 210 may be used to provide a demographic profile of a given speaker. For example, usage of certain phrases may be indicative of an ethnic group of a national origin of a given speaker. As will be described below, this may be determined using some sort of statistical model, or some sort of heuristics, or some sort of scoring system.

In some embodiments, it may be useful to analyze frequencies of words (or word combinations) in a given segment of conversation using a language model engine 256.

For example, it is recognized that more educated people tend to use a different set of vocabulary in their speech than less educated people. Thus, it is possible to prepare pre-determined conversation ‘training sets’ of more educated people and conversation ‘training sets’ of less educated people. For each training set, frequencies of various words may be computed. For each pre-determined conversation ‘training set,’ a language model of word (or word combination) frequencies may be constructed.

According to this example, when a segment of conversation is analyzed, it is possible (i.e. for a given speaker or speakers) to compare the frequencies of word usage in the analyzed segment of conversation, and to determine if the frequency table more closely matches the training set of more educated people or less educated people, in order to obtain demographic data (i.e.

This principle could be applied using pre-determined ‘training sets’ for native English speakers vs. non-native English speakers, training sets for different ethnic groups, and training sets for people from different regions. This principle may also be used for different conversation ‘types.’ For example, conversations related to computer technologies would tend to provide an elevated frequency for one set of words, romantic conversations would tend to provide an elevated frequency for another set of words, etc. Thus, for different conversation types, or conversation topics, various training sets can be prepared. For a given segment of analyzed conversation, word frequencies (or word combination frequencies) can then be compared with the frequencies of one or more training sets.

The same principle described for word frequencies can also be applied to sentence structures—i.e. certain pre-determined demographic groups or conversation type may be associated with certain sentence structures. Thus, in some embodiments, a part of speech (POS) tagger 264 is provided.

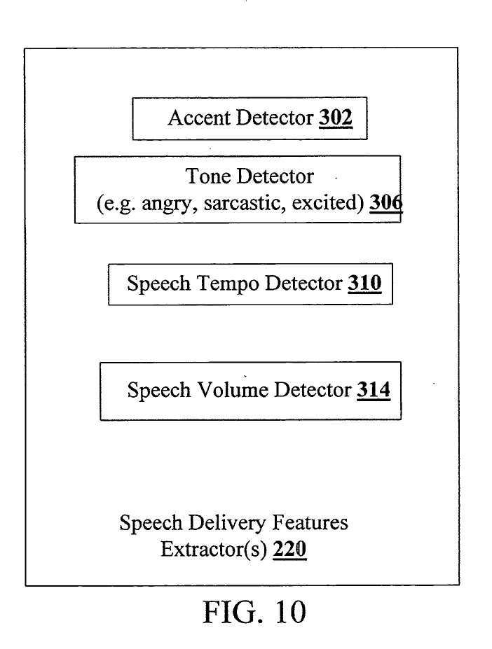

A Discussion of FIGS. 10-15

FIG. 10 provides a block diagram of an exemplary system 220 for detecting one or more speech delivery features. This includes an accent detector 302, tone detector 306, speech tempo detector 310, and speech volume detector 314 (i.e. for detecting loudness or softness.

As with any feature detector or computation engine disclosed herein, speech delivery feature extractor 220 or any component thereof may be pre-trained with ‘training data’ from a training set.

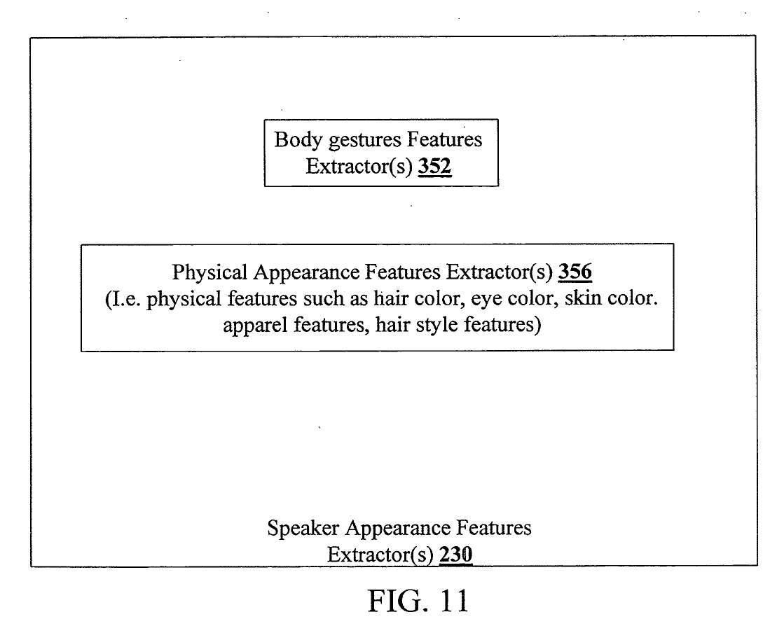

FIG. 11 provides a block diagram of an exemplary system 230 for detecting speaker appearance features—i.e. for video media content for the case where the multi-party conversation includes both voice and video. This includes a body gestures feature extractor(s) 352, and physical appearance features extractor 356.

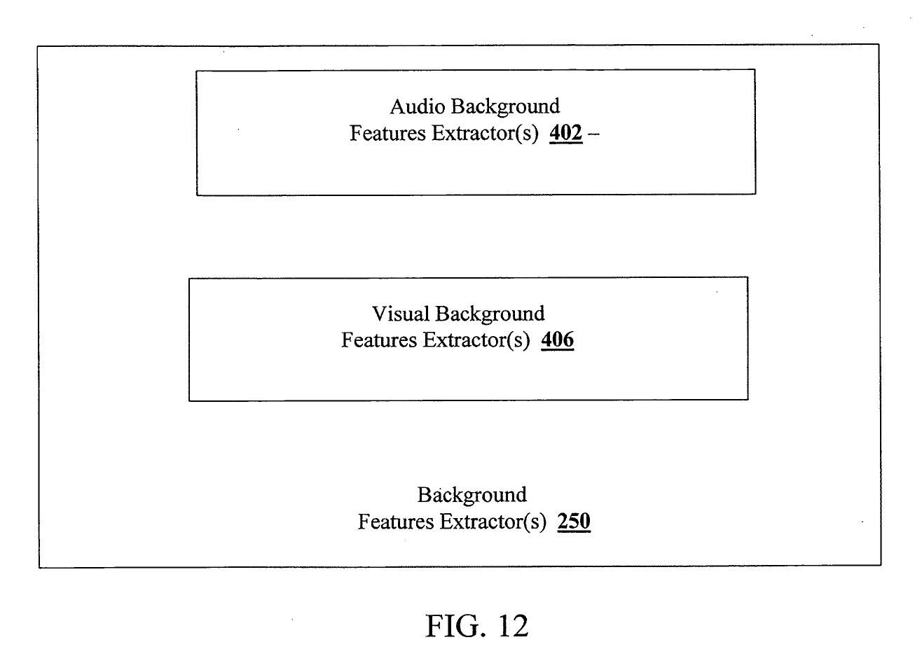

FIG. 12 provides a block diagram of an exemplary background feature extractor(s) 250. This includes (i) audio background features extractor 402 for extracting various features of background sounds or noise including but not limited to specific sounds or noises such as pet sounds, an indication of background talking, an ambient noise level, a stability of an ambient noise level, etc; and (ii) visual background features extractor 406 which may, for example, identify certain items or features in the room, for example, certain products are brands present in a room.

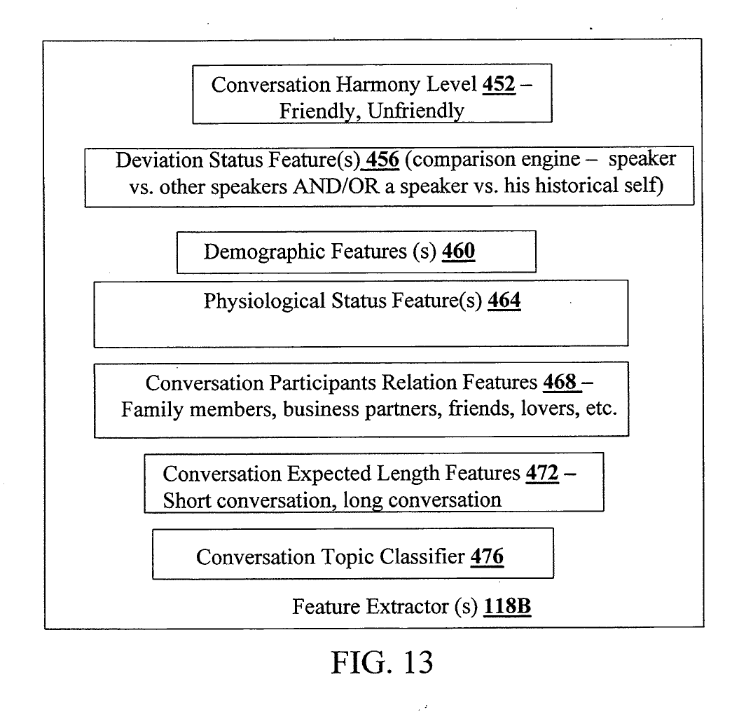

FIG. 13 provides a block diagram of additional feature extractors 118 for determining one or more features of the electronic media content of the conversations. Certain features may be ‘combined features’ or ‘derived features’ derived from one or more other features.

This includes a conversation harmony level classifier (for example, determining if a conversation is friendly or unfriendly and to what extent) 452, a deviation feature calculation engine 456, a feature engine for demographic feature(s) 460, a feature engine for physiological status 464, a feature engine for conversation participants relation status 468 (for example, family members, business partners, friends, lovers, spouses, etc), conversation expected length classifier 472 (i.e. if the end of the conversation is expected within a ‘short’ period of time, the information may be carried out differently than for the situation where the end of the conversation is not expected within a short period of time), conversation topic classifier 476, etc.

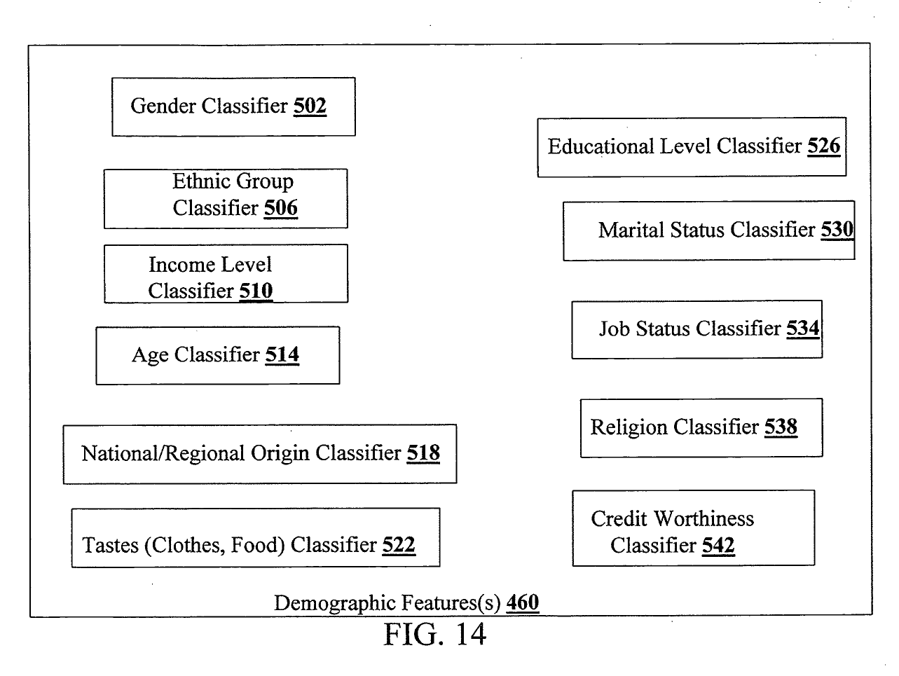

FIG. 14 provides a block diagram of exemplary demographic feature calculators or classifiers. This includes gender classifier 502, ethnic group classifier 506, income level classifier 510, age classifier 514, national/regional origin classifier 518, tastes (for example, clothes and good) classifier 522, educational level classifier 5267, marital status classifier 530, job status classifier 534 (i.e. employed vs. unemployed, manager vs. employee, etc), religion classifier 538 (i.e. Jewish, Christian, Hindu, Muslim, etc).

In one example related to retrieval and/or presentation of information in accordance with a demographic profile and related to religion classifier 538, a religion of a person is detected, for example, using key-words, accent and/or speaker location. One example relates to a speaker with who often speaks about Jewish topics, or may often listen to Klezmer music or Yiddish music in the background. In one particular example, if the speaker is discussing a desire to cook dinner with a friend, certain recipes may be presented to the speaker—if the speaker is Jewish, recipes that include pork may be filtered out.

In another example, if the Jewish speaker is speaking with a friend about the need to find a spouse, personal ads (i.e. from a dating site) may be biased towards people who indicate an interest in Judiasm.

In the description and claims of the present application, each of the verbs, “comprise” “include” and “have”, and conjugates thereof are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of providing information-retrieval services, the method comprising:
a) monitoring a multi-party voice conversation not directed at the entity doing the monitoring; and
b) in accordance with content of said monitored voice conversation, retrieving and presenting information to at least one party of said multi-party voice conversation.

2) The method of claim 1 wherein said retrieving includes retrieving at least one of:
i) a social-network profile;
ii) a weather forecast;
iii) a traffic forecast;
iv) a Wikipedia entry;
v) a news article;
vi) an online forum entry;
vii) a blog entry;
viii) a social bookmarking web service entry;
ix) a music clip; and
x) a film clip.

3) The method of claim 1 wherein said includes assigning a keyword weight in accordance with an demographic parameter of a given party of said multi-party voice conversation estimated from electronic media of said multi-party conversation, said estimated demographic parameter being selected from the group consisting of:
i) an age parameter;
ii) a gender parameter; and
iii) an ethnicity parameter.

4) The method of claim 1 wherein said retrieving includes selecting or emphasizing an information-source from a plurality of candidate information-sources in accordance with an demographic parameter of a given party of said multi-party voice conversation estimated from electronic media of said multi-party conversation, said estimated demographic parameter being selected from the group consisting of:
i) an age parameter;
ii) a gender parameter; and
iii) an ethnicity parameter.

5) The method of claim 1 wherein said retrieving includes effecting a disambiguation in accordance with an demographic parameter of a given party of said multi-party voice conversation estimated from electronic media of said multi-party conversation, said estimated demographic parameter being selected from the group consisting of:
i) an age parameter;
ii) a gender parameter; and
iii) an ethnicity parameter.

6) The method of claim 1 wherein said includes assigning a keyword weight in accordance with a speech delivery feature of a given party of said multi-party voice conversation estimated from electronic media of said multi-party conversation said speech delivery feature being selected from the group consisting of:
i) a loudness parameter;
ii) a speech tempo parameter; and
iii) an emotional outburst parameter.

7) The method of claim 1 wherein said retrieving includes selecting or emphasizing an information-source from a plurality of candidate information-sources in accordance with a geographic location of a given party of said multi-party voice conversation estimated from electronic media of said multi-party conversation.

8) The method of claim 1 wherein said retrieving includes selecting or emphasizing an information-source from a plurality of candidate information-sources in accordance with an accent feature of at least one given party of said multi-party voice conversation.

9) The method of claim 1 wherein said retrieving includes assigning a keyword weight in accordance with an demographic parameter of a given party of said multi-party voice conversation estimated from electronic media of said multi-party conversation, said estimated demographic parameter being selected from the group consisting of:
i) an age parameter;
ii) a gender parameter; and
iii) an ethnicity parameter.

10) The method of claim 1 wherein said information-presenting for a first set of words extracted from said multi-party conversation includes displacing earlier-presented retrieved information associated with a second earlier set of words extracted from said multi-party conversation in accordance with relative speech delivery parameters of said first and second set extracted words in accordance with a speech delivery feature being selected from the group consisting of:
i) a loudness parameter;
ii) a speech tempo parameter; and
iii) an emotional outburst parameter.

11) The method of claim 1 wherein said multi-party voice conversation is carried out between a plurality of client terminal devices communicating via a wide-area network, and for a given client device of said client device plurality:
i) said information retrieval is carried out for incoming content relative to said given client device; and
ii) said information presenting is on a display screen of said given client device.

12) A method of providing information-retrieval services, the method comprising:
a) monitoring a terminal device for incoming media content and outgoing media content of a multi-party conversation; and
b) in accordance with said incoming media content, retrieving information over a remote network and presenting said retrieved information on said monitored-terminal device.

13) The method of claim 1 wherein said retrieving includes sending content of said multi-party conversation to an Internet search engine, and said presenting includes presenting search results from said Internet search engine.

14) The method of claim 12 wherein said retrieving includes retrieving at least one of:
i) a social-network profile;
ii) a weather forecast;
iii) a traffic forecast;
iv) a Wikipedia entry;
v) a news article;
vi) an online forum entry;
vii) a blog entry;
viii) a social bookmarking web service entry;
ix) a music clip; and
x) a film clip.

15) A method of providing information-retrieval services, the method comprising:
a) monitoring a given terminal client device for an incoming or outgoing remote call; and
b) upon detecting a said incoming or outgoing remote call, sending content of said detected incoming call or outgoing call over a wide-area network to a search engine; and
c) presenting search results from said search engine on said monitored terminal device.
